(19) United States
(12) Patent Application Publication
(10) Pub. No.: US 2026/0120510 A1
(43) Pub. Date: Apr. 30, 2026

(54) AI-BASED DECISION MAKING SUPPORT TYPE FACIAL EXPRESSION SUPPORT DEVICE, FACIAL EXPRESSION SUPPORT METHOD, AND RECORDING MEDIUM

(71) Applicant: NEC Corporation, Tokyo (JP)

(72) Inventors: Makoto IWASAKI, Tokyo (JP); Tomonori ISHIDA, Tokyo (JP); Naoko KURISAKI, Tokyo (JP)

(73) Assignee: NEC Corporation, Tokyo (JP)

(21) Appl. No.: 19/362,767

(22) Filed: Oct. 20, 2025

(30) Foreign Application Priority Data
Aug. 11, 2024 (JP) 2024-195639

(51) Int. Cl. G06V 40/16; G06V 40/20

(52) U.S. Cl. CPC G06V 40/174; G06V 40/20

(57) ABSTRACT

To support facial expression training by selecting an appropriate image as a goal, in a facial expression support device, a processor extracts a feature amount for identifying a face of a user from a facial image of the user. The processor extracts a facial image of a desired facial expression as a target image from a terminal device used by the user and a social networking service (SNS) used by the user, based on the feature amount. The processor selects a goal image from the target image based on evaluation by a third party on the target image, and outputting the goal image.

### INCORPORATION BY REFERENCE

This application is based upon and claims the benefit of priority from Japanese Patent Application 2024-195639, filed on Nov. 8, 2024, the disclosure of which is incorporated herein in its entirety by reference.

### TECHNICAL FIELD

The present disclosure relates to a support technology for making facial expressions.

### BACKGROUND ART

In a scene where there are many people who meet each other for the first time, such as in a case of entering a school and entering a company, many people want to improve their impression by increasing a smile. In a scene involving a face-to-face interaction on business, such as a job interview or an online meeting, a facial expression and a way of speaking also affect results. Therefore, in various situations, there are people who are worried about not being able to make a facial expression suitable for a scene. Patent Document 1 describes a system for searching for an image including a face having a desired facial expression from many images.
Patent Document 1: Japanese Patent Application Laid-Open under No. 2007-213378

### SUMMARY

Conventionally, there is known a service for performing facial expression training by capturing an image of oneself with a camera using a facial expression recognition technology while viewing a goal facial expression image. However, in this service, a general goal facial expression image considered to be statistically favorable is used, and thus the service is not always useful for a person who is in the training.

One of objects of the present disclosure is to support facial expression training by selecting an appropriate image as a goal.

According to an example aspect of the present invention, there is provided a facial expression support device including:
at least one memory configured to store instructions; and
at least one processor configured to execute the instructions to:
a feature extraction means configured to extract a feature amount for identifying a face of a user from a facial image of the user;
a target image extraction means configured to extract a facial image of a desired facial expression as a target image from a terminal device used by the user and a social networking service (SNS) used by the user, based on the feature amount; and
a goal image selection means configured to select a goal image from the target image based on evaluation by a third party on the target image, and outputting the goal image.

According to another example aspect of the present invention, there is provided a facial expression support method executed by a facial expression support device, the facial expression support method including:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.

According to still another example aspect of the present invention, there is provided a non-transitory computer-readable recording medium storing a program executed by a facial expression support device including a computer, the program causing the computer to execute processing of:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.

### Effect

According to the present disclosure, it is possible to support facial expression training by selecting an appropriate image as a goal.

### BRIEF DESCRIPTION OF THE DRAWINGS

FIG. 1 illustrates an example of a schematic configuration of a facial expression support system according to the present disclosure;

FIGS. 2A and 2B are block diagrams illustrating an example of a hardware configuration of a server and a user terminal;

FIG. 3 is a block diagram illustrating an example of a functional configuration of the server;

FIG. 4 is a diagram schematically illustrating information to be transmitted from the user terminal to the server;

FIG. 5 is an example of a display screen;

FIG. 6 is a flowchart illustrating an example of image selection processing;

FIG. 7 is a block diagram illustrating an example of another functional configuration of a facial expression support device; and

FIG. 8 is a flowchart illustrating another example of image selection processing.

### EXAMPLE EMBODIMENTS

Hereinafter, example embodiments of the present disclosure will be described with reference to the drawings.

### First Example Embodiment

### (Overall Configuration)

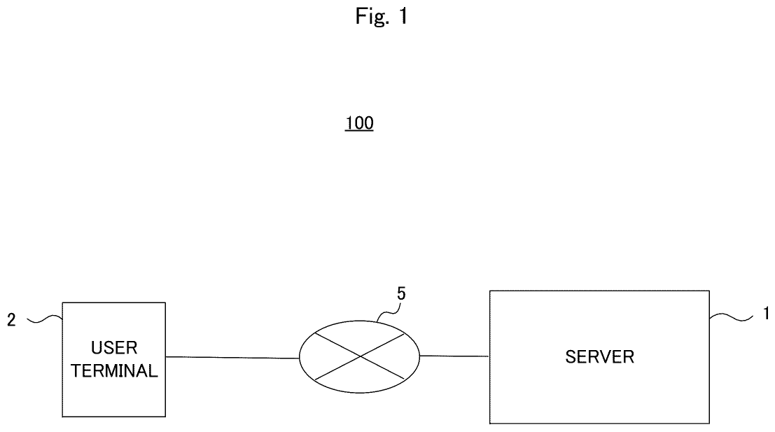

FIG. 1 is an example of a schematic configuration of a facial expression support system 100 to which a facial expression support device of the present disclosure is applied. The facial expression support system 100 is a system that supports facial expression training of a user by selecting and displaying a goal image of a facial expression ideal for the user, based on evaluation by a third party. Specifically, for example, the facial expression support system 100 extracts a facial image of a desired facial expression as a target image from images (hereinafter, also referred to as “facial images”) including the user's own face posted on a social networking service (SNS) by the user or facial images of a person similar to the user on the Internet. Next, the facial expression support system 100 selects the goal image from target images in consideration of evaluation by a third party such as the number of views, and displays the selected goal image on a terminal device of the user.

In the facial expression support system 100 depicted in FIG. 1, a server 1 and a user terminal 2 are communicably connected via a network 5 such as the Internet. The user is a person who does training for making a facial expression suitable for a scene in various situations.

The user terminal 2 is a smartphone, a tablet, a PC, or the like used by the user, and transmits a facial image of the user or input information indicating a desired facial expression to the server 1 and receives the goal image from the server 1. The user terminal 2 is an example of a terminal device used by the user of the present disclosure.

The server 1 is an information processing device that processes, stores, transmits, and receives various data, and the server 1 receives a facial image of the user and input information from the user terminal 2, selects the goal image suitable for the facial expression training of the user, and transmits the goal image to the user terminal 2. The server 1 may be a virtual server in a cloud environment. The server 1 is an example of a facial expression support device of the present disclosure.

### (Hardware Configuration)

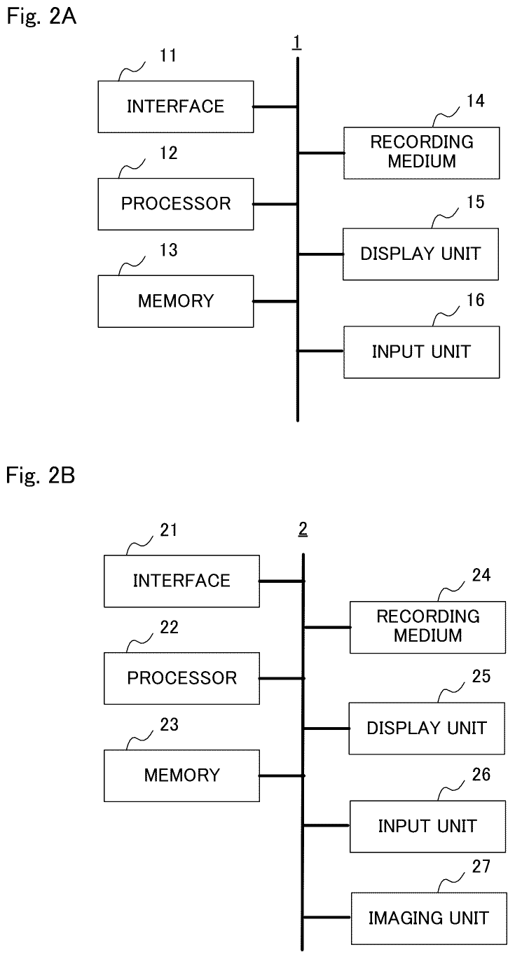

FIG. 2A is a block diagram illustrating an example of a hardware configuration of the server 1. As illustrated in the drawing, the server 1 includes an interface (Interface) 11, a processor 12, a memory 13, a recording medium 14, a display unit 15, and an input unit 16.

The interface 11 exchanges data with the user terminal 2. The interface 11 is used to receive a facial image of the user and input information from the user terminal 2, and transmit the goal image suitable for the facial expression training of the user to the user terminal 2.

The processor 12 is a computer such as a central processing unit (CPU), and controls the entire server 1 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In a case where the server 1 executes image selection processing, the program recorded in the recording medium 14 is loaded into the memory 13 and executed by the processor 12.

The display unit 15 displays a predetermined image by, for example, a liquid crystal display (LCD). The input unit 16 is a keyboard, a mouse, a touch panel, or the like, and is used by an operator who manages the server 1.

FIG. 2B is a block diagram illustrating an example of a hardware configuration of the user terminal 2. As illustrated in the drawing, the user terminal 2 includes an interface 21, a processor 22, a memory 23, a recording medium 24, a display unit 25, an input unit 26, and an imaging unit 27.

The interface 21 exchanges data with the server 1 via the network 5. The interface 21 is used to transmit a facial image of the user and input information indicating a desired facial expression to the server 1, and receive the goal image from the server 1.

The processor 22 is a computer such as a CPU, and controls the entire user terminal by executing a program prepared in advance. As the processor 22, a CPU, a GPU, a DSP, an MPU, an FPU, a PPU, a TPU, a quantum processor, a microcontroller, or a combination of these can be used.

The memory 23 includes a ROM, a RAM, or the like. The memory 23 stores a program executed by the processor 22. The memory 23 is also used as a working memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 displays a predetermined image by, for example, an LCD. The input unit 26 is a touch panel or the like, and is used in a case where the user performs a predetermined operation. The imaging unit 27 includes a camera, and acquires captured still image data and moving image data as an image.

### (Functional Configuration)

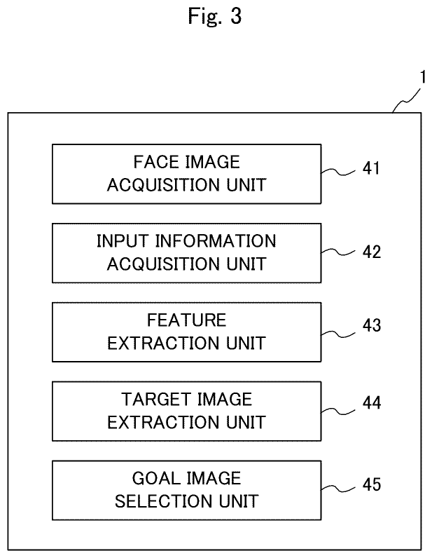

FIG. 3 is a block diagram illustrating an example of a functional configuration of the server 1. The server 1 functionally includes a facial image acquisition unit 41, an input information acquisition unit 42, a feature extraction unit 43, a target image extraction unit 44, and a goal image selection unit 45.

The facial image acquisition unit 41, the input information acquisition unit 42, the feature extraction unit 43, the target image extraction unit 44, and the goal image selection unit 45 are implemented by the processor 12 executing a program.

The facial image acquisition unit 41 acquires a facial image of the user who does the facial expression training. The facial image may be either still image data or moving image data. The user transmits the user's own facial image held in advance and/or a facial image of the user captured by the user terminal 2 to the server 1, by a predetermined operation using the user terminal 2.

The input information acquisition unit 42 acquires input information indicating a facial expression desired by the user. The input information is a text or an image indicating a facial expression desired by the user. In a case where it is difficult to verbalize the desired facial expression, the user may input a facial image of another person having a facial expression desired by the user, and the input information includes one or more of a text and an image. For example, in a case where the facial expression desired by the user is a “smile”, the user transmits a text “smile” or an image of a smile to the server 1 as the input information, by a predetermined operation using the user terminal 2. In the text, a scene or a situation assumed by the user can be freely described, such as “a smile that gives a good impression to a person the user meets for the first time”, “a facial expression in a case of chairing a meeting”, and the like. The facial expression desired by the user is not limited to a positive facial expression such as a smile, and can be set to any facial expression including a negative facial expression such as an angry face.

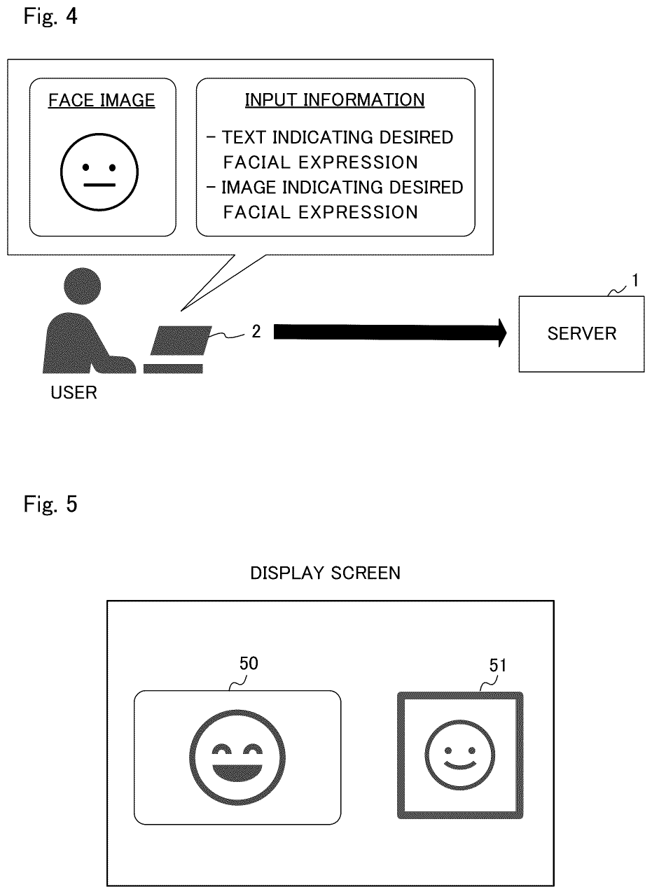

FIG. 4 is a diagram schematically illustrating information to be transmitted from the user terminal 2 to the server 1. As illustrated in FIG. 4, the user transmits a facial image of the user and one or more of a text and an image indicating a desired facial expression to the server 1, by a predetermined operation using the user terminal 2.

The feature extraction unit 43 extracts a feature amount for identifying the face of the user from the facial image of the user. As the feature amount, for example, various known feature amounts can be used, such as a feature amount used in a face authentication technology. In the present disclosure, the server 1 extracts the feature amount from the facial image of the user by the feature extraction unit 43. However, the present disclosure is not limited thereto, and the user terminal 2 may extract the feature amount from the facial image of the user and transmit the feature amount to the server 1. As described above, a method by which the server 1 acquires the feature amount can be freely set.

The target image extraction unit 44 extracts the target images, based on the input information and the feature amount for identifying the face of the user. Specifically, the target image extraction unit 44 determines the feature amount related to the facial expression desired by the user, based on the input information and the feature amount for identifying the face of the user. For example, in a case where the user inputs a text “smile” as the input information, the target image extraction unit 44 performs modification of a feature amount related to a smile, on the feature amount extracted from the facial image of the user, to generate a feature amount related to the facial expression (smile) desired by the user.

In a case where the user inputs a facial image of another person having the desired facial expression as the input information, the target image extraction unit 44 performs modification of a feature amount extracted from the facial image of another person having the facial expression desired by the user, on the feature amount extracted from the facial image of the user, to generate a feature amount related to the facial expression desired by the user.

In a case where the facial expression desired by the user is, for example, a facial expression in a predetermined scene or situation such as “a facial expression in a case of chairing a meeting”, the target image extraction unit 44 extracts a facial image of an exemplary facial expression in the scene or the situation desired by the user from the Internet or the like, and extracts a feature amount from the facial image. Next, the target image extraction unit 44 performs modification of the feature amount extracted from the facial image of the exemplary facial expression, on the feature amount extracted from the facial image of the user, to generate a feature amount related to the facial expression of the scene or the situation (in a case of chairing a meeting) desired by the user.

Then, by using the feature amount related to the facial expression desired by the user, the target image extraction unit 44 extracts, as a target image, a facial image of the facial expression desired by the user from images on the Internet including the SNS used by the user or images stored in the terminal device used by the user. Specifically, the target image extraction unit 44 extracts, as the target image, an image having a feature amount similar to the feature amount related to the facial expression desired by the user. The target image extraction unit 44 may download and acquire a facial image to be the target image, or may list link destinations.

Here, the SNS used by the user is a service in which images and comments can be posted on the Internet and individuals such as friends can be connected to each other. The terminal device used by the user is a smartphone or a tablet including the user terminal 2. As a result, the target image extraction unit 44 can extract the facial image of the desired facial expression as the target image from the user's own facial images posted on the SNS by the user. The target image is not limited to still image data, and may be an image obtained by cutting off a momentary facial expression of moving image data.

The target image extraction unit 44 may extract, as the target image, not only a facial image on the SNS used by the user but also a facial image of a person who is similar to the user and has the facial expression desired by the user from the Internet. That is, a facial image of another person having a feature similar to that of the face of the user may be extracted as the target image. As a result, since the facial image of another person having substantially the same face as the user can also be extracted as the target image, it is possible to provide the goal image appropriate for the facial expression training of the user, even in a case where the number of images posted and the number of images saved on the SNS by the user are small. There is also an advantage that the user can more easily find an ideal appearance in a facial image of another person who is similar to the user than in the user's own facial image.

The goal image selection unit 45 selects the goal image from among the target images in consideration of evaluation by a third party, and transmits the selected goal image to the user terminal 2. Examples of the evaluation by the third party include the number of views, the number of empathetic reactions, and an engagement rate. The number of views is the number of times a posted image is viewed on the SNS, and the number of empathetic reactions is the number of reactions indicating empathy such as “like” performed on the posted image, for example. In addition to those indicating empathy such as “like”, examples of the reaction also include “bad” indicating undesirability or low quality, a comment on the posted image, and reposting citing the posted image. The engagement rate is an index for measuring how many reactions have been made to the posted image, and is calculated by, as an example, “the number of reactions to the posted image=the number of views of the posted image×100”.

In consideration of the evaluation by the third party, for example, in a case where the facial expression desired by the user is a “smile”, the goal image selection unit 45 selects a target image having a largest number of reactions indicating empathy such as “like”, and sets the selected target image as the goal image. Whereas, in a case where the facial expression desired by the user is an “angry face”, a target image having a largest number of reactions indicating undesirability such as “bad” is selected as the goal image. The goal image selection unit 45 may simply select a target image having many reactions as the goal image, or may place importance on quality of reactions and select a target image having many specific reactions as the goal image. A plurality of reactions may be considered in combination.

Any reaction can be taken for the evaluation by the third party considered by the goal image selection unit 45 in accordance with the facial expression desired by the user. The evaluation by the third party can be calculated as a numerical value. For example, the goal image selection unit 45 calculates a numerical value indicating the evaluation by the third party based on any one or more of the number of views, the number of empathetic reactions, the number of comments, the number of citations, and the engagement rate of the target image.

The goal image selection unit 45 may select not only one goal image but also a plurality of goal images. In a case of selecting a plurality of goal images, the user may do training by displaying all of the plurality of goal images, or may do training by selecting and displaying one of the plurality of goal images by a predetermined operation using the user terminal 2.

The goal image selection unit 45 transmits the goal image to the user terminal 2 to display the goal image. FIG. 5 is an example of a display screen including the goal image. The goal image selection unit 45 creates a display screen including a real-time image area 50 and a goal image area 51 as illustrated in FIG. 5, for example, and transmits the display screen to the user terminal 2. The real-time image area 50 is an area for displaying a real-time facial image of the user captured by the imaging unit 27 of the user terminal 2. The goal image area 51 is an area for displaying the selected goal image. The user does the facial expression training in such a way to approach the goal image while comparing the user's real-time facial image and the goal image on the display screen displayed on the user terminal 2.

In the above configuration, the input information acquisition unit 42, the feature extraction unit 43, the target image extraction unit 44, and the goal image selection unit 45 of the server 1 are examples of an input information acquisition means, a feature extraction means, a target image extraction means, and a goal image selection means of the present disclosure, respectively.

### (Image Selection Processing)

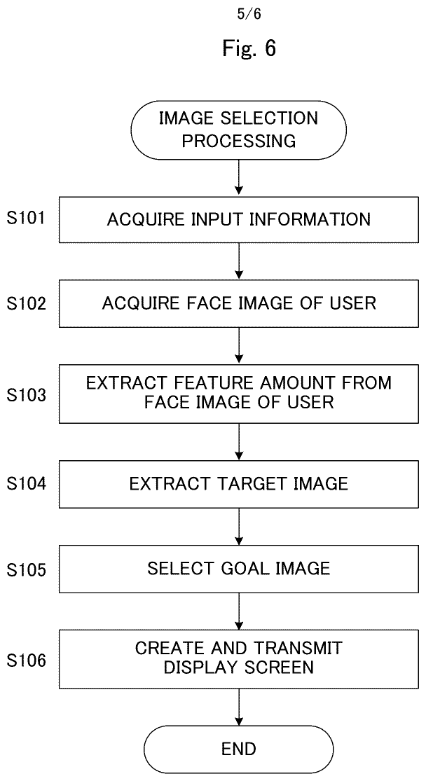

Next, image selection processing by the server 1 will be described. FIG. 6 is a flowchart illustrating an example of the image selection processing by the server 1. This processing is achieved by the processor 12 illustrated in FIG. 2A executing a program prepared in advance.

First, the server 1 acquires input information from the user terminal 2 (step S101). Next, the server 1 acquires a facial image of the user who does the facial expression training, from the user terminal 2 (step S102). Next, the server 1 extracts a feature amount for identifying the face of the user from the facial image of the user (step S103).

Based on the feature amount and the input information, the server 1 extracts the target images from a terminal device owned by the user and the Internet including the SNS used by the user (step S104). Next, the server 1 selects a goal image from the target images, based on evaluation by a third party on the target image (step S105). Next, the server 1 creates a display screen including the goal image, and transmits screen information related to the display screen to the user terminal 2 (step S106). The user terminal 2 having acquired the screen information displays the display screen including the goal image. Thus, the image selection processing ends.

According to such the facial expression support system 100, the server 1 can provide an appropriate goal image in consideration of evaluation by a third party, to the user who does the facial expression training. In other words, the server 1 can support the facial expression training of the user by selecting an appropriate image as a goal. As a result, the user can do the facial expression training with reference to not a general goal image but a goal image evaluated to be desirable from a third party's viewpoint viewed from people around the user, that is, a goal image of an ideal facial expression of the user determined by other people. By using a facial image of the user or a facial image of a person similar to the user as the goal image instead of a general goal image, the user can do effective facial expression training.

### First Modification Example

Although the input information in the example embodiment described above includes a text and an image indicating the facial expression desired by the user, the present disclosure is not limited thereto, and the input information may include a condition of the target image. The condition of the target image is, for example, a condition related to a capture date and time or a posting date and time of the target image, and examples thereof include “the capture date and time of the facial image is within one year”. Accordingly, the target image extraction unit 44 can extract a target image selected carefully according to the condition from the Internet, based on the feature amount and the input information.

### Second Modification Example

The target image extraction unit 44 in the example embodiment described above may extract, as a target image, a facial image of another person similar to the user from the Internet, based on the feature amount and the input information. In this case, if there are a plurality of other persons similar to the user, the target image extraction unit 44 preferentially sets, as a target image, a facial image of a person having a large number of interactions on the SNS or the like used by the user. The number of interactions is determined by the target image extraction unit 44 based on, for example, whether the person is a follower, or there is an exchange of comments or messages, with reference to an interaction history of the SNS. Without limiting to the large number of interactions, for example, the target image extraction unit 44 may preferentially set, as the target image, a facial image of a person with a large number of images taken together with the user.

Accordingly, the target image extraction unit 44 can efficiently search the Internet for the target image by focusing on followers and close persons who frequently exchange messages, that is, people around the user. By setting a facial image of a close person as the goal image, the user can do the facial expression training with familiarity.

### Third Modification Example

The server 1 may use text emotion recognition artificial intelligence (AI) that estimates an emotion from an input text. In this case, for example, by inputting a text indicating the facial expression desired by the user to the text emotion recognition AI, the input information acquisition unit 42 recognizes an emotion of the facial expression desired by the user. Accordingly, the target image extraction unit 44 can extract the target image in consideration of the emotion causing the facial expression, in addition to the text and the image indicating the facial expression desired by the user.

In a case where there is a comment describing a predetermined facial image posted on the SNS, the target image extraction unit 44 recognizes an emotion of the comment on the SNS by inputting the comment to the text emotion recognition AI. Accordingly, the target image extraction unit 44 can extract the target image in consideration of the emotion of the comment describing the facial image. Specifically, the target image extraction unit 44 extracts the target image, based on the feature amount and the input information with priority given to a posted facial image in which the emotion of the comment matches the emotion of the facial expression desired by the user.

### Fourth Modification Example

In the example embodiment described above, the user uses the user terminal 2, but the present disclosure is not limited to this, and the user may use the user terminal having a function of the server 1. In this case, the user terminal can execute the image selection processing performed by the server 1, and select and output an optimal goal image for the user to do the facial expression training.

### Second Example Embodiment

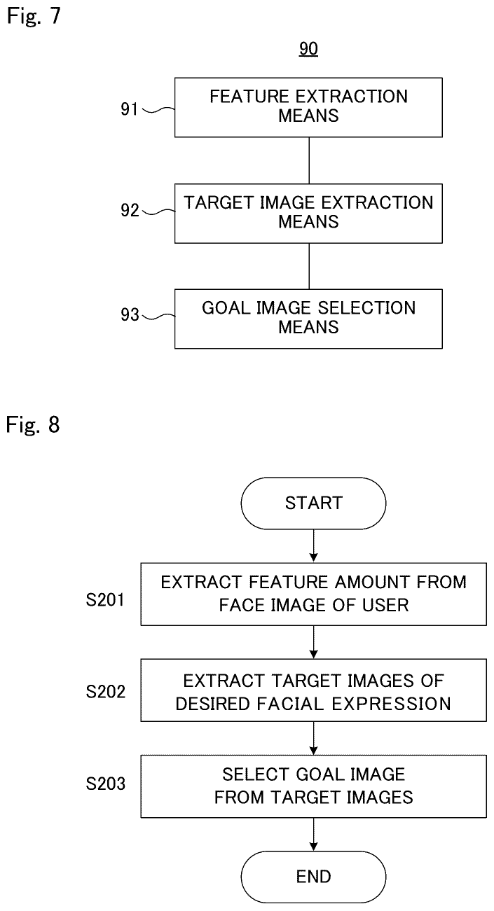

FIG. 7 is a block diagram illustrating an example of a functional configuration of a facial expression support device of the present disclosure. A facial expression support device 90 includes a feature extraction means 91, a target image extraction means 92, and a goal image selection means 93.

FIG. 8 is a flowchart illustrating an example of processing by the facial expression support device 90. The feature extraction means 91 extracts a feature amount for identifying the face of the user from a facial image of the user (step S201). Based on the feature amount, the target image extraction means 92 extracts facial images of a desired facial expression as the target images from the terminal device used by the user and the SNS used by the user (step S202). The goal image selection means 93 selects a goal image from the target images, based on evaluation by a third party on the target images, and outputs the goal image (step S203).

Some or all of the example embodiments described above (including the modification examples, the same applies hereinafter) may also be described as the following supplementary notes, but are not limited to the following supplementary notes.

### (Supplementary Note 1)

A facial expression support device comprising:
a feature extraction means configured to extract a feature amount for identifying a face of a user from a facial image of the user;
a target image extraction means configured to extract a facial image of a desired facial expression as a target image from a terminal device used by the user and a social networking service (SNS) used by the user, based on the feature amount; and
a goal image selection means configured to select a goal image from the target image based on evaluation by a third party on the target image, and outputting the goal image.

### (Supplementary Note 2)

The facial expression support device according to supplementary note 1, comprising:
an input information acquisition means configured to acquire input information indicating a desired facial expression, wherein
the target image extraction means extracts the target image based on the feature amount and the input information.

### (Supplementary Note 3)

The facial expression support device according to supplementary note 2, wherein the input information includes one or more of a text or an image indicating a desired facial expression.

### (Supplementary Note 4)

The facial expression support device according to supplementary note 3, wherein the target image extraction means estimates an emotion of one or more of a text included in input information and a text written in a comment on a target image, by using text emotion recognition artificial intelligence (AI) that estimates an emotion from an input text, and the target image extraction means extracts the target image based on the feature amount and the emotion of the text.

### (Supplementary Note 5)

The facial expression support device according to supplementary note 2, wherein
the input information includes a condition related to a capture date and time or a posting date and time of the target image, and
the target image extraction means extracts a target image that meets the condition.

### (Supplementary Note 6)

The facial expression support device according to supplementary note 1, wherein the evaluation by the third party is calculated based on any one or more of a number of views, a number of empathetic reactions, a number of comments, a number of citations, and an engagement rate of the target image.

### (Supplementary Note 7)

The facial expression support device according to supplementary note 1, wherein the target image extraction means extracts, as a target image, a facial image of a desired facial expression of a person having a feature close to a feature of the face of the user from Internet based on the feature amount.

### (Supplementary Note 8)

The facial expression support device according to supplementary note 7, wherein, among persons having a feature close to a feature of the face of the user, the target image extraction means extracts the target image preferentially from a person having a large number of interactions with the user on the SNS.

### (Supplementary Note 9)

A facial expression support method executed by a facial expression support device, the facial expression support method comprising:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.

### (Supplementary Note 10)

A program executed by a facial expression support device including a computer, the program causing the computer to execute processing of:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.

Some or all of the configurations described in supplementary notes 2 to 8 dependent on the above-described supplementary note 1 can also be dependent on supplementary notes 9 and 10 by the same dependency relationship as in supplementary notes 2 to 8. Some or all of the configurations described as the supplementary notes can be similarly dependent on not only the supplementary notes 1, 8, and 9, but also various pieces of hardware and software, and various recording means or systems for recording software without departing from the above-described example embodiments.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the supplementary notes. That is, it is a matter of course that the present disclosure includes various modifications and corrections that can be made by those of ordinary skill in the art in accordance with the entire disclosure including the supplementary notes and the technical idea.

### DESCRIPTION OF SYMBOLS

1 Server
2 User terminal
11, 21 Interface
12, 22 Processor
13, 23 Memory
14, 24 Recording medium
15, 25 Display unit
16, 26 Input unit
27 Imaging unit
41 Face image acquisition unit
42 Input information acquisition unit
43 Feature extraction unit
44 Target image extraction unit
45 Goal image selection unit
100 Expression support system

1. A facial expression support device comprising:
at least one memory configured to store instructions; and
at least one processor configured to execute the instructions to:
a feature extraction means configured to extract a feature amount for identifying a face of a user from a facial image of the user;
a target image extraction means configured to extract a facial image of a desired facial expression as a target image from a terminal device used by the user and a social networking service (SNS) used by the user, based on the feature amount; and
a goal image selection means configured to select a goal image from the target image based on evaluation by a third party on the target image, and outputting the goal image.

2. The facial expression support device according to claim 1, comprising:
an input information acquisition means configured to acquire input information indicating a desired facial expression, wherein
the target image extraction means extracts the target image based on the feature amount and the input information.

3. The facial expression support device according to claim 2, wherein the input information includes one or more of a text or an image indicating a desired facial expression.

4. The facial expression support device according to claim 3, wherein the target image extraction means estimates an emotion of one or more of a text included in input information and a text written in a comment on a target image, by using text emotion recognition artificial intelligence (AI) that estimates an emotion from an input text, and the target image extraction means extracts the target image based on the feature amount and the emotion of the text.

5. The facial expression support device according to claim 2, wherein
the input information includes a condition related to a capture date and time or a posting date and time of the target image, and
the target image extraction means extracts a target image that meets the condition.

6. The facial expression support device according to claim 1, wherein the evaluation by the third party is calculated based on any one or more of a number of views, a number of empathetic reactions, a number of comments, a number of citations, and an engagement rate of the target image.

7. The facial expression support device according to claim 1, wherein the target image extraction means extracts, as a target image, a facial image of a desired facial expression of a person having a feature close to a feature of the face of the user from Internet based on the feature amount.

8. The facial expression support device according to claim 7, wherein, among persons having a feature close to a feature of the face of the user, the target image extraction means extracts the target image preferentially from a person having a large number of interactions with the user on the SNS.

9. A facial expression support method executed by a facial expression support device, the facial expression support method comprising:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.

10. A non-transitory computer-readable recording medium storing a program executed by a facial expression support device including a computer, the program causing the computer to execute processing of:
extracting a feature amount for identifying a face of a user from a facial image of the user;
extracting a facial image of a desired facial expression as a target image from a terminal device used by the user and a social networking service (SNS) used by the user, based on the feature amount; and
selecting a goal image from the target image based on evaluation by a third party on the target image, and outputting the goal image.
